(19) United States
(12) Patent Application Publication
(10) Pub. No.: US 2022/0410616 A1
(43) Pub. Date: Dec. 29, 2022

(54) GLASS-LAMINATED PANEL WITH BOW RESISTANCE

(71) Applicant: Corning Incorporated, Corning, NY (US)

(72) Inventors: Peter Steven Cole, Corning, NY (US); Ray Gage Gibson, III, Bath, NY (US); Khaled Layouni, Fontainebleau (FR); Breanna Elizabeth Marcellus, Corning, NY (US); Fraaz Tahir, Santa Clara, CA (US)

(21) Appl. No.: 17/778,453

(22) PCT Filed: Nov. 19, 2020
(86) PCT No.: PCT/US2020/061163

§ 371 Date: May 20, 2022

Related U.S. Application Data
(60) Provisional application No. 62/940,372, filed on Nov. 26, 2019.

(51) Int. Cl. B44C 5/04; B32B 15/10; B32B 17/06; B32B 21/08; B32B 7/12; B32B 37/12

(52) U.S. Cl. CPC B44C 5/04; B32B 15/10; B32B 17/061; B32B 21/08; B32B 7/12; B32B 37/1284; B32B 2250/04; B32B 2255/06; B32B 2307/546; B32B 2307/7246; B32B 2607/02

(57) ABSTRACT

An apparatus includes: an MDF portion including an upper surface, a lower surface, and a lateral surface between the upper and lower surfaces; a stress buffer including an upper surface and a lower surface; a glass portion including an upper surface and a lower surface; and a moisture-inhibiting portion that limits a flow of moisture into and out of the MDF portion through at least one of the lower surface or the lateral surface of the MDF portion.

### CROSS REFERENCE TO RELATED APPLICATIONS

This application claims the benefit of priority under 35 U.S.C. § 119 of U.S. Provisional Application No. 62/940,372, filed Nov. 26, 2019, the content of which is incorporated herein by reference in its entirety.

### BACKGROUND

Certain techniques disclosed herein relate to architectural panels (also referred to herein as “panels”). In particular, certain techniques disclose glass-laminated panels in which the glass demonstrates reduced bowing.

Architectural panels, which may be usable for walls and furniture, may include laminates. The use of such laminates may reduce costs by allowing less expensive core materials to be used with more aesthetically pleasing surface materials. Glass may be laminated to a structure that includes medium-density fiberboard (MDF).

When constructing an architectural panel that includes a glass laminate, the glass may be laminated onto a backing material (e.g., a decorative backing material). The resulting panel may have a relatively high-gloss finish that may be aesthetically pleasing as well as relatively robust for cleaning and wear resistance.

### SUMMARY

According to certain techniques, an apparatus includes: a medium-density fiberboard (“MDF”) portion including an upper surface, a lower surface, and a lateral surface between the upper surface and the lower surface; a stress buffer (e.g., including steel) including an upper surface and a lower surface, wherein the lower surface of the stress buffer is adhered to the upper surface of the MDF portion; a glass portion including an upper surface and a lower surface, wherein the lower surface of the glass portion is adhered to the upper surface of the stress buffer; and a moisture-inhibiting portion (e.g., including aluminum and/or polyethylene terephthalate) that limits a flow of moisture into and out of the MDF portion through at least one of the lower surface or the lateral surface of the MDF portion. The moisture-inhibiting portion may be adhered to the lower surface of the MDF portion and/or the lateral surface of the MDF portion. The moisture-inhibiting portion adhered to the lower surface of the MDF portion may include a material different from one included in the moisture-inhibiting portion adhered to the lateral surface of the MDF portion. There may be no steel portion below the lower surface of the MDF portion.

According to certain techniques, a method includes: adhering a lower surface of a stress buffer (e.g., including steel) to an upper surface of an MDF portion; adhering a lower surface of a glass portion to an upper surface of the stress buffer; and arranging a moisture-inhibiting portion (e.g., including aluminum and/or polyethylene terephthalate) to limit a flow of moisture into and out of the MDF portion through at least one of a lower surface of the MDF portion or a lateral surface of the MDF portion. The method may further include adjusting a moisture content of the MDF portion before arranging the moisture-inhibiting portion. The adjusted moisture content of the MDF portion may be controlled according to historical humidity conditions for an expected end-use location. The moisture-inhibiting portion may be adhered to the lower surface of the MDF portion and/or the lateral surface of the MDF portion. The moisture-inhibiting portion adhered to the lower surface of the MDF portion may include a material different from one included in the moisture-inhibiting portion adhered to the lateral surface of the MDF portion. There may be no steel portion below the lower surface of the MDF portion.

### BRIEF DESCRIPTION OF SEVERAL VIEWS OF THE DRAWINGS

FIG. 1 illustrates positive and negative bowing in a laminate with respect to a substrate.

FIG. 2A is a non-proportional representation of a perspective view of an architectural panel, in accordance with various embodiments of the present disclosure.

FIG. 2B is an exploded view of FIG. 2A, in accordance with various embodiments of the present disclosure.

FIG. 3 is a non-proportional representation of a cross-sectional view of an architectural panel, in accordance with various embodiments of the present disclosure.

FIG. 4 illustrates a flow chart for a method of making an architectural panel, in accordance with various embodiments of the present disclosure.

FIG. 5A-C illustrate different examples of a moisture inhibitor 170, in accordance with various embodiments of the present disclosure.

FIG. 6 is a graph depicting bow (mm/m) as a function of time (days) for a plurality of different samples, including various embodiments of the present disclosure.

FIG. 7 depicts a graph depicting Bow for two different samples, a large panel and a small panel, depicted as bow (mm/m) as a function of time (days), in accordance with various embodiments of the present disclosure.

FIG. 8 depicts a graph comparing small vs. large panels without edge protection, showing bow (mm/m) as a function of time (days), for 3 different samples, in accordance with various embodiments of the present disclosure.

FIG. 9 depicts a graph comparing the average bow for a double z-clip mounting attachment, depicted as average bow (mm/m) as a function of N, where N is number of z-clips per sample, in accordance with various embodiments of the present disclosure.

FIG. 10 depicts a graph comparing the average bow for a double z-clip mounting attachment with optional frame, depicted as average bow (mm/m) as a function of N, where N is number of z-clips per sample, in accordance with various embodiments of the present disclosure.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

Glass laminates (such as Corning® Willow® glass) are finding greater application as a decorative product in the architectural wall panel industry. The Willow® glass may be laminated over a steel buffer material that, in turn, may be laminated to an MDF core. Either the steel or the glass may be painted according to aesthetic desires. The MDF portion, a wood-based product, may be sensitive to changes in humidity. Such changes may result in an undesirable inward or outward bow of the panel due to the asymmetric nature of the glass/steel/MDF laminate stack.

When materials having different expansion properties are bound together (either directly or indirectly), they may experience forces when they expand or contract relative to one another. Laminates (e.g., glass laminates) on panels that use MDF may bow in response to the changing size of an MDF component. MDF may expand and/or contract in response to changes in humidity and temperature. Humidity variations, in particular, can cause undesirably large changes in size of MDF. Moisture can enter (ingress) or exit (egress) MDF in response to environmental humidity conditions. This may cause undesirable degrees of “bowing” in the laminate. Bow may be aesthetically unpleasing, result in de-lamination or cracks in laminates, cause undesirable stress in laminates, and apply stress to the mounting fixtures such that a panel may come loose from the wall or support fixture.

A stress buffer (e.g., a layer, such as a metal or steel layer) may be interposed between the MDF component and a glass laminate. The stress buffer may reduce bow from temperature variations in the use environment. While stress buffer may also reduce the degree of bowing in the glass laminate, the stress buffer itself may exhibit undesirable bowing. Even with the stress buffer, the degree of bowing in the glass laminate (due to bowing in the stress buffer and/or the glass laminate itself) may exceed what is desired.

The MDF component may be relatively susceptible to expansion and contraction due to changes in moisture content, whereas the glass laminate and steel laminate may not. Changes in moisture content of the MDF component may be influenced by changes in the relative humidity (Δ % RH) of the surrounding environment with respect to the initial conditions (e.g., initial moisture content) when the panel was constructed. Changes in the relative humidity (and consequently the size of the MDF component) may result in warpage or bow of the panel.

According to certain techniques, the cost of panels that demonstrate improved laminate bowing performance may be reduced. For example, the techniques may reduce the need for using certain component(s) that mechanically stabilize a panel. One such component may be a steel layer on a back side (a side opposite the user). Such a steel layer may not be needed with a panel constructed according to techniques disclosed herein.

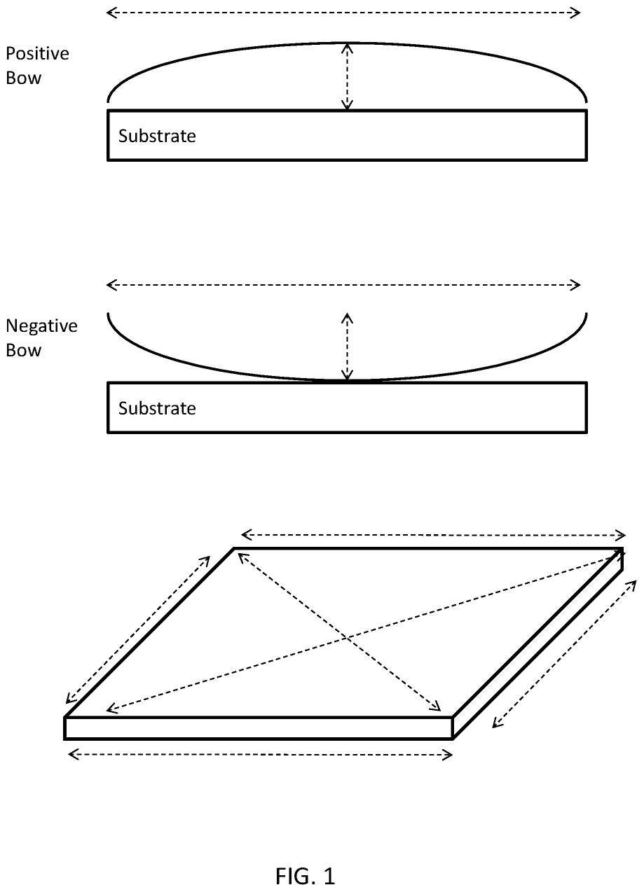

FIG. 1 illustrates positive and negative bowing in a laminate with respect to a substrate. The degree of bowing (or bow) may be measured with reference to the diagonals or edges of the substrate. According to one technique for measuring bow, a maximum deviation of the height of the laminate from the substrate is determined in millimeters. The length of the substrate (e.g., diagonals, edges, or other desired lengths) over which bow is measured is determined in meters. The resulting bow value is determined by dividing the height deviation by the chosen substrate length. For example, if the maximum deviation of the height of the laminate from the substrate is 3 mm and the panel is 1 m, then the resulting bow value would be 3 mm/m (3 millimeters per meter).

While certain techniques are applicable to reduce any degree of bowing, when using a Corning® Willow® glass laminate on an MDF-based panel, a bow value of 5 mm/m may be undesirable when evaluated across the diagonal of the panel. Although there is no specific bow standard for architectural wall panels, the value of 5 mm/m is also disclosed in European Standard EN-438 “Decorative high-pressure laminates (HPL) sheets based on thermosetting resins, specifications.”

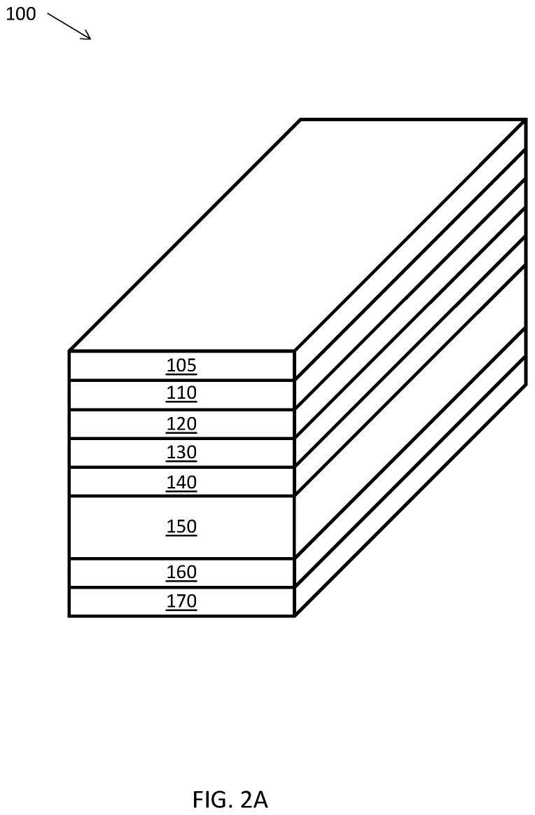

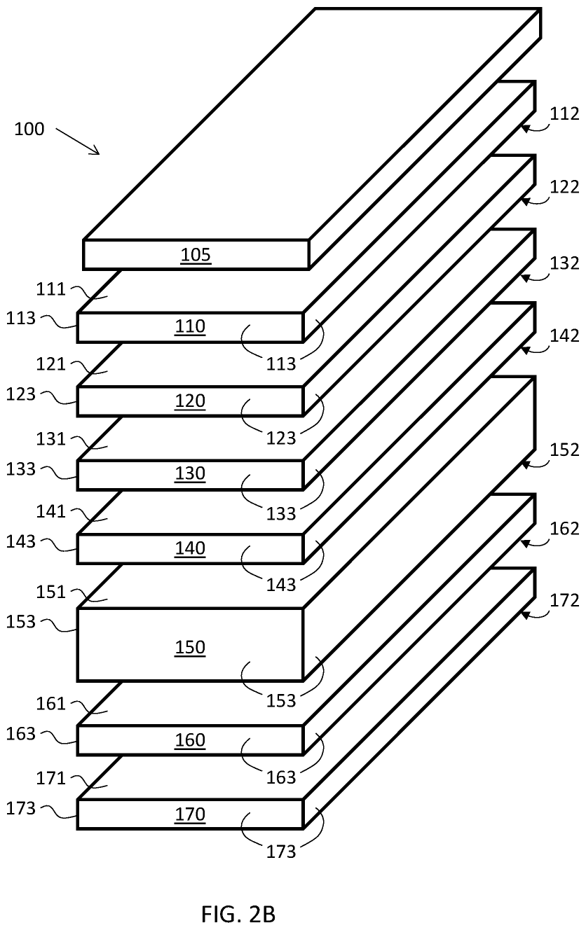

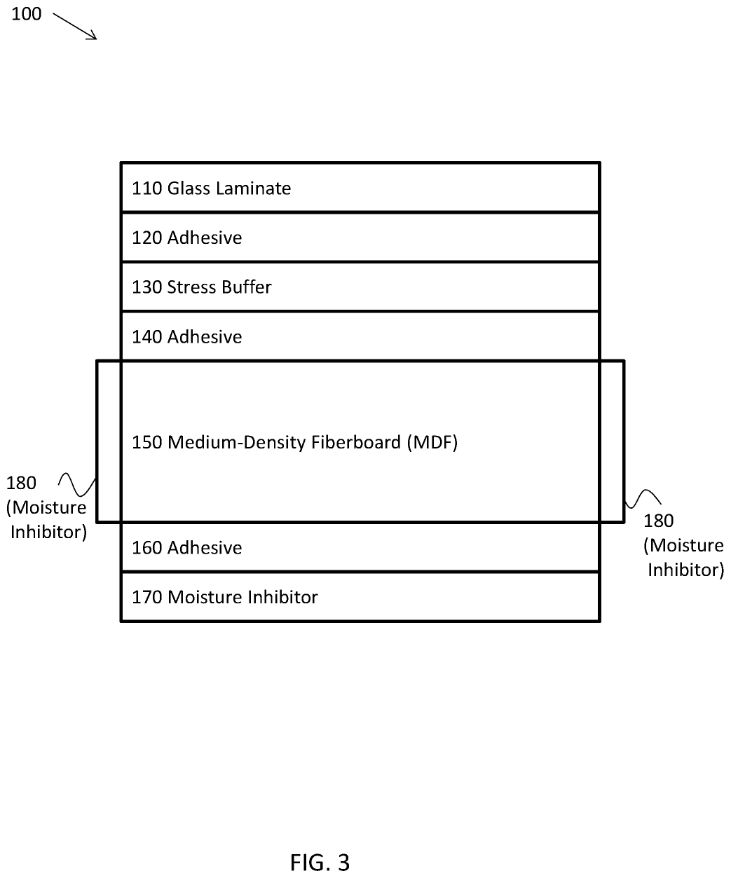

FIGS. 2A and 2B illustrate non-proportional representations (non-exploded and exploded) of a perspective view of an architectural panel 100, according to certain techniques. FIG. 3 is a non-proportional representation of a cross-sectional view of an architectural panel 100, according to certain techniques. The panel 100 may include an MDF portion 150 with an upper surface 151, lower surface 152, and lateral surface 153. Above MDF portion 150, stress buffer 130 is adhered to the upper surface 151 of MDF portion 150 with adhesive layer 140. Stress buffer 130 includes upper surface 131, lower surface 132, and lateral surface 133. Above stress buffer 130, glass laminate 110 is adhered to the upper surface 131 of the stress buffer 130 with an adhesive layer 120. Glass laminate 110 includes upper surface 111, lower surface 112, and lateral surface 113. Below MDF portion 150, a moisture inhibitor 170 may be adhered to the lower surface 152 of MDF portion 150 with adhesive layer 160. Moisture inhibitor 170 may include upper surface 171, lower surface 172, and lateral surface 173. Moisture inhibitor 170 may be applied directly to MDF portion 150 without adhesive. On part or all of the lateral surfaces 153 of MDF portion 150, moisture inhibitor 180 may be directly applied or adhered using an adhesive (not shown). Adhesive layer 120 may include an upper surface 121, lower surface 122, and lateral surface 123. Adhesive layer 140 may include an upper surface 141, lower surface 142, and lateral surface 143. Adhesive layer 160 may include an upper surface 161, lower surface 162, and lateral surface 163.

The upper surface of the panel 100 may also include a paint layer 105. While paint layer 105 is shown above the upper surface 111 of the laminate 110, paint 105 may be applied to all or a portion of laminate 110—e.g., all or a portion of the upper surface 111, lower surface 112, and/or lateral surface 113. Paint layer 105 may also be applied to other surfaces in panel 100, such as all or a portion of lateral surfaces 123, 133, 143, 153, 163, 173, and/or 180 (see FIG. 3). Instead of or in addition to paint layer 105, a decorative adhesive may be applied to all or a portion of the upper surface 111, lower surface 112, and/or lateral surface 113 of the laminate 110. Alternatively or in addition, the decorative adhesive may be applied to the upper surface 131 and/or lateral surface 133 of the stress buffer 130. Paint may be applied in several ways, for example, by brush, roller, or spray. Thickness may be in the range of 20 μm to 50 μm or higher if more coats are applied, or if a thicker paint film desired for aesthetic considerations. These thicknesses may be associated with primers and enamel paints. Latex and other coating materials may also be employed.

Glass laminate 110 may include a material such as Corning® Willow® glass. Other options include relatively thin glass (e.g., less than 0.5 mm thick). Glass laminate 110 may be up to 250 μm thick, or optionally up to 0.5 mm thick.

Adhesive 120 may be a relatively optically clear adhesive such as 3M 82** series (e.g., 8211-8215). Adhesive 120 may be 50 μm thick (or thinner, such as 25 μm), or optionally as high as 0.5 mm thick. Adhesive 120 may be relatively soft such that it does not stiffen against bow. However, if too thick, adhesive 120 could also undesirably absorb water. Adhesive 120 may be pressure sensitive.

Stress buffer 130 may be steel, such as Deco Steel®. Stress buffer 130 may be 520 μm thick, or optionally be between 200 μm and 520 μm thick. Stress buffer 130 may be as high as 1 mm thick.

Adhesive 140 may be similar to adhesive 120. Adhesive 140 may be opaque or translucent (i.e., not relatively optically clear). Adhesive 140 may be 50 μm thick, or optionally as high as 0.5 mm thick. Adhesive 140 may be relatively soft such that it does not stiffen against bow. However, if too thick, adhesive 140 could also undesirably take up water.

MDF portion 150 may be 12.7 mm (½ inch) thick, or optionally between 3 mm and 25 mm. Adhesive 160 may be similar to adhesive 120 and/or adhesive 140. Adhesive 160 may be opaque or translucent (i.e., not relatively optically clear). Adhesive 160 may be 5-10 μm thick.

Moisture inhibitor 170 may include aluminum (e.g., foil or tape). The water vapor transmission rate for moisture inhibitor 170 may be less than 0.1 g/m²/day. Moisture inhibitor 170 may include additional materials, such as polyethylene terephthalate (PET). Moisture inhibitor 170 may optionally include steel. Moisture inhibitor 170 may be one layer (e.g., a layer of aluminum foil having a thickness between 7-40 μm, or even up to 100 μm) or a plurality of layers including different materials.

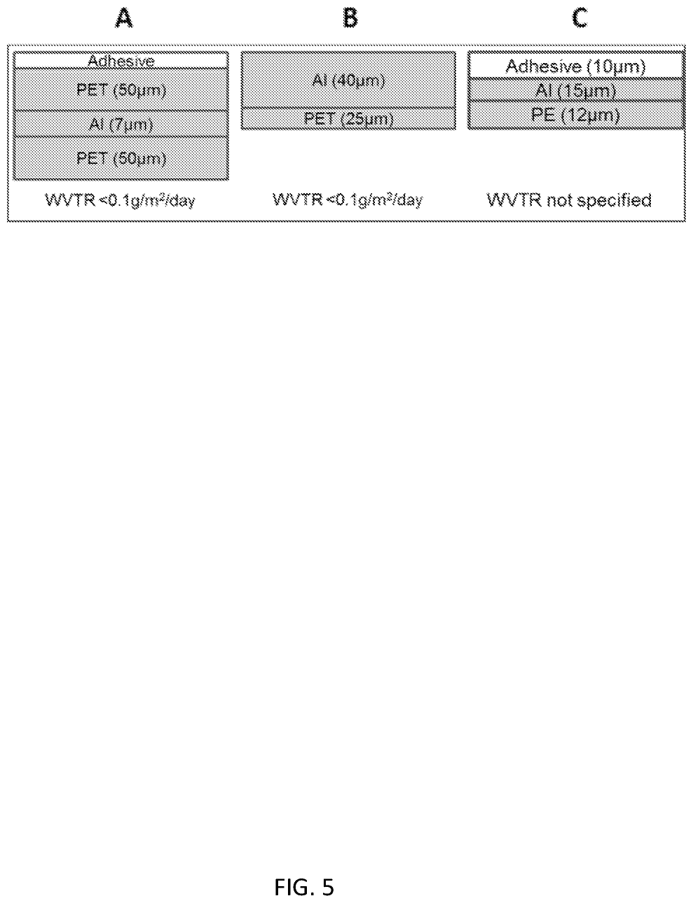

FIG. 5A-C illustrates three additional examples of a moisture inhibitor 170, in accordance with various embodiments of the present disclosure. For example, as shown in Example B, moisture inhibitor 170 may include an aluminum layer above a PET layer (e.g., 40 μm and 25 μm thick, respectively). As shown in Example C, moisture inhibitor 170 may include an aluminum layer above a PET layer (e.g., 15 μm and 12 μm thick, respectively). As shown in Example A, moisture inhibitor 170 may include a PET layer above an aluminum layer above another PET layer (e.g. 50 μm, 7 μm, and 50 μm thick, respectively). Moisture inhibitor 170 may also include other materials, such as stainless steel (e.g., between 0.1-0.38 mm), polyurethane, wax (e.g., paraffin), wax paper, epoxy (e.g., polyester polymer material), and/or latex paint.

The total cross-sectional thicknesses may be from ¼″ to 1″. According to certain techniques, the thicknesses may be ½″ or ¾″ since these are common dimensions used for building construction. The solutions may work on thinner and thicker cross-sections as well, with the appropriate adjustments to the pre-conditioning time, for example (e.g., thicker MDF may take longer to stabilize to a pre-set moisture content, while thinner MDF may take a shorter time).

Moisture inhibitor 180 may be like or similar to moisture inhibitor 170, except that it may be applied to some or all of the lateral surfaces of MDF portion 150. Moisture inhibitor 180 may or may not be used to construct panel 100. For example, the panel 100 may include moisture inhibitor 170, but not moisture inhibitor 180. Or the panel 100 may include moisture inhibitor 180, but not moisture inhibitor 170. Or the panel 100 may include both moisture inhibitor 170 and moisture inhibitor 180.

Moisture inhibitor 180 may include an alkyd material, such as primer (e.g., oil-based primer) or paint (e.g., latex paint). Moisture inhibitor 180 may include a marine paint. Moisture inhibitor 180 may include aluminum and/or PET. As another option, moisture inhibitor 180 may be applied to the lateral surfaces of one or more other layers of the panel 100. Any combination of other layers 110, 120, 130, 140, 160, and/or 170 could also have a moisture inhibitor 180 on one or more lateral surfaces. For example, the entire panel 100 (or more portions than just the MDF portion 150) may first be constructed before the moisture inhibitor 180 is applied to all or a portion of the lateral surfaces of the constructed portion of the panel 100.

In addition to construction of panel 100, it may also be possible to pre-condition MDF portion 150. For example, moisture content of MDF portion 150 may be adjusted before applying moisture inhibitors 170 and/or 180. As discussed, a significant factor in causing bow may be when MDF portion 150 expands or contracts in response to changes in moisture content. Such changes may be driven by differences the relative humidity (% RH) between initial humidity conditions of MDF portion 150 when laminated, changes during shipping and storage, and ultimately to the final use-case condition (after installation). MDF expands or contracts in response to change in % RH (Δ% RH). While these changes in size may be constrained by stress buffer 130 and glass laminate 110, the degree of bowing in glass laminate 110 and/or stress buffer 130 may be undesirable.

To limit the influence of relative humidity, the moisture content of MDF portion 150 may be adjusted before applying adhesives and moisture inhibitors 170 and/or 180. According to one technique for pre-conditioning MDF portion 150, MDF portion 150 may be placed in an environmental chamber (controlled atmosphere chamber), or even a moisture controlled room. The air in the chamber (or room) may be humidified to a desired level at a given temperature, such as approximately room temperature (i.e., between about 20-50° C., for example, 23° C.).

MDF portion 150 may be placed in the chamber for a suitable length of time (on the order of days, such as 7 days), whereby moisture is either added or removed from MDF portion according to the relative humidity in the chamber. The relative humidity in the chamber may be set to a value according to historical humidity conditions for an expected end-use location. For example, if an expected end-use location has an average relative humidity of 50%, then the humidity in the chamber may be set to 50%. As another example, the relative humidity in the chamber may be set to a level higher or lower than an average relative humidity of an expected end-use location.

There may be three ways to measure moisture content in MDF. First, the entire panel or a cut-out may be oven-dried, and the mass before and after the oven may be recorded. The loss in mass may correspond to the pre-test moisture content. This may be a destructive test. Second, a resistance moisture meter may be used. This method may work by inserting pin-type electrodes to pass a current through the MDF and estimating the moisture content from the measured resistance. Dry MDF may have higher resistance than moisture-filled MDF. Third, a dielectric moisture meter may be used. This method may employ flat plate electrode(s) to measure resistance, so it may be relatively or completely non-invasive. One such example is Lignomat Pinless Moisture Meter type “Ligno-Scanner S.”

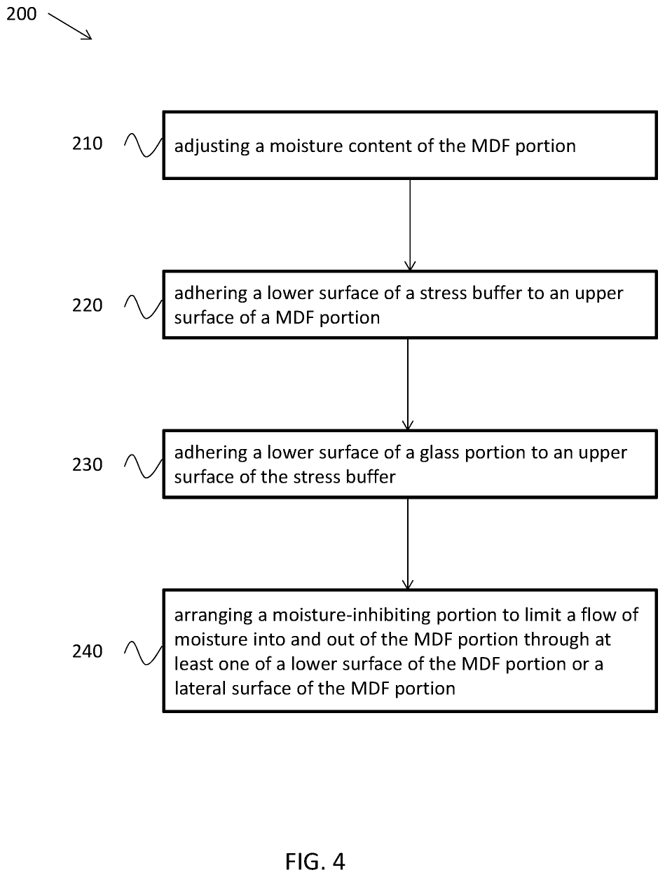

FIG. 4 illustrates a flow chart 200 for a method of making an architectural panel, according to certain techniques. Steps of flow chart 200 may be performed in a different order. For example, step 220 may be performed after steps 230 and 240. The method may be performed according to other techniques discussed herein. For example, the method may be performed using panel 100. At step 210, a moisture content of MDF portion 150 may be adjusted, such that MDF portion 150 is pre-conditioned. At step 220, a lower surface of stress buffer 130 may be adhered to an upper surface of MDF portion 150. Such adhesion may be facilitated using adhesive 140. At step 230, a lower surface of glass laminate 110 may be adhered to an upper surface of stress buffer 130. Such adhesion may be facilitated using adhesive 120. At step 240, moisture-inhibiting portion 170 and/or 180 may be arranged to limit a flow of moisture into and out of MDF portion 150 through at least one of a lower surface of MDF portion 150 or a lateral surface of the MDF portion 150.

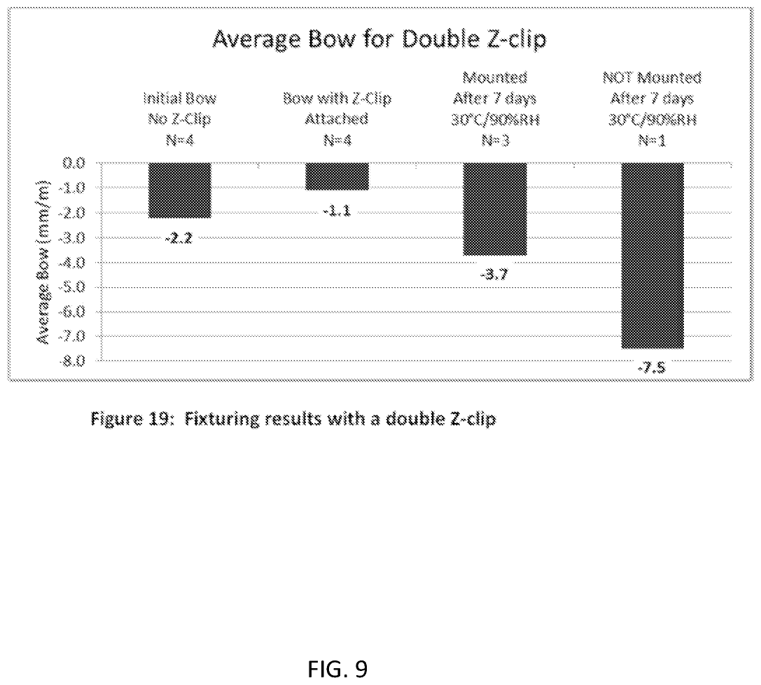

In addition to the composition of panel 100 and pre-conditioning techniques for MDF portion 150, the type of mechanical connectors for securing panel 100 to an architectural structure (e.g., wall or furniture) may be appropriately selected. For example, “Z-clips” may be used to secure panel 100 to walls. Z-clips are lengths of extruded aluminum, mounted to the backside of panels that mate to corresponding pieces attached to the wall. When mounted, Z-clips may reduce the amount of bow by 3.5-4 mm/m in comparison with a panel with Z-clips that are not attached to the wall. These results are valid for 600×900 mm panels, with the Z-clips attached to the top and bottom of the 900 mm length, which is the panel width. For panels whose vertical dimension exceeds 600 mm, additional Z-clips may be used to minimize bowing. Testing results for bowing of panels 100 when mounted with Z-clips are shown in FIG. 9.

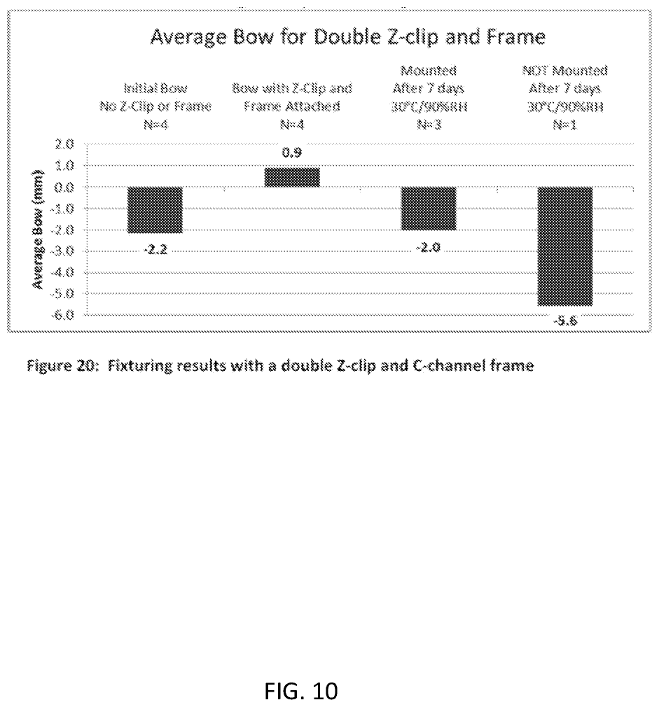

Another type of mechanical connector for securing panel 100 to an architectural structure is a C-channel frame. Such a frame may reduce the amount of potential bow by increasing stiffness of the panel. A combination of Z-clips and a C-channel frame may be used. FIG. 10 shows test results of bowing for panels 100 mounted with Z-clips and secured with a C-channel frame.

Table 1 below illustrates various possibilities for material usage in moisture inhibitor 170 and moisture inhibitor 180, although these are in no way an exhaustive listing of all potential configurations for panel 100. Instead, any combination of the above-listed materials may be possible, as well as those materials contemplated by an artisan with ordinary skill. The C467MP and A467MP adhesives are examples of double-sided transfer tape, and other such adhesives could be substituted.

TABLE 1

| Moisture Inhibitor 170 | Moisture Inhibitor 180 |
|---|---|
| Aluminum (10 μm) | Primer and paint |
| Aluminum (40 μm) and | Primer and paint |
| C467MP adhesive | |
| Aluminum and PET | Primer and paint |
| Aluminum (7 μm) and | Primer and paint |
| A467MP adhesive | |
| Aluminum and PET | Primer |

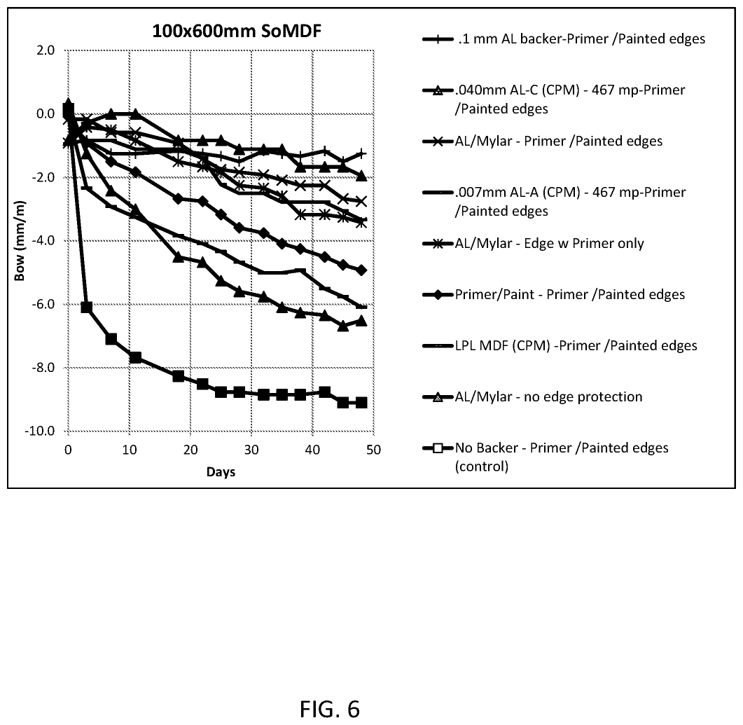

FIG. 6 illustrates testing results of different panel 100 configurations. The panels 100 tested were 100×600 mm (width×length) with a laminate 110 including Willow® glass above a stress buffer 130 including steel, and further above MDF 150. FIG. 6 is a graph showing the change in bow in mm/m over time (50 days maximum). As indicated, different panels 100 were tested with different moisture inhibitors 170 and 180.

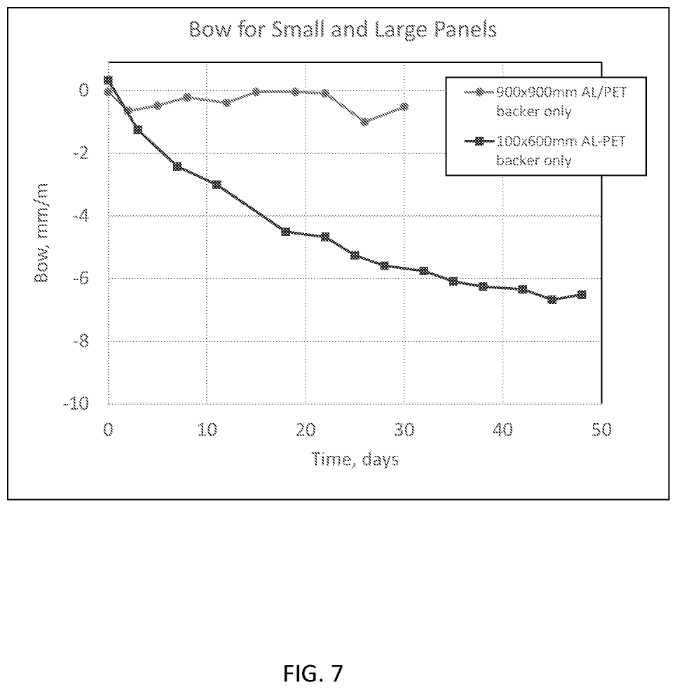

FIG. 7 illustrates test results of two different sizes of panels 100 and the varying bow results over time. The panels 100 had a moisture inhibitor 170 including aluminum and PET. The panels 100 did not have a moisture inhibitor 180. As can be seen, panels 100 with a size of 900×900 mm exhibited less bow than panels 100 with a size of 100×600 mm.

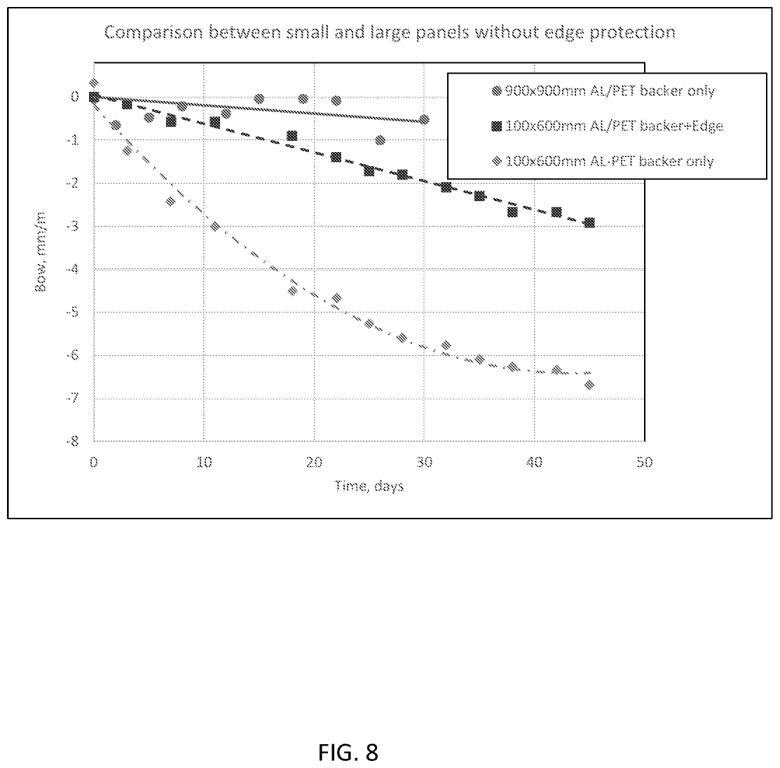

FIG. 8 illustrates test results comparing relatively small (100×600 mm) and large (900×900 mm) panels with moisture inhibitor 170 including aluminum and PET, but with only one set of samples having moisture inhibitor 180.

While certain techniques are disclosed with respect to glass laminates on panels that include MDF, the techniques may be applicable to other circumstances. For example, other types of laminates besides glass may demonstrate less bowing as a result of these techniques. As another example, other types of woods or humidity-sensitive components may be used in constructing panels besides MDF, and laminates on such panels may benefit from reduced bowing as a result of certain techniques. As yet another example, the techniques may be used in other applications besides architectural panels, and the principles may be the same. All such variations are expressly contemplated within the scope of certain techniques disclosed herein.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. An apparatus comprising:
a medium-density fiberboard (“MDF”) portion including an upper surface, a lower surface, and a lateral surface between the upper surface and the lower surface;
a stress buffer including an upper surface and a lower surface, wherein the lower surface of the stress buffer is adhered to the upper surface of the MDF portion;
a glass portion including an upper surface and a lower surface, wherein the lower surface of the glass portion is adhered to the upper surface of the stress buffer; and
a moisture-inhibiting portion that limits a flow of moisture into and out of the MDF portion through at least one of the lower surface or the lateral surface of the MDF portion.

2. The apparatus of claim 1, wherein the stress buffer comprises steel.

3. The apparatus as in claim 1, wherein the moisture-inhibiting portion comprises aluminum.

4. The apparatus as in claim 1, wherein the moisture-inhibiting portion further comprises polyethylene terephthalate.

5. The apparatus as in claim 1, wherein the moisture-inhibiting portion is adhered to at least one of the lower surface of the MDF portion or the lateral surface of the MDF portion.

6. The apparatus as in claim 1, wherein the moisture-inhibiting portion is adhered with an adhesive to the lower surface of the MDF portion.

7. The apparatus as in claim 1, wherein the moisture-inhibiting portion is adhered with an adhesive to the lateral surface of the MDF portion.

8. The apparatus as in claim 1, wherein the moisture-inhibiting portion is adhered with an adhesive to the lower surface of the MDF portion and the lateral surface of the MDF portion.

9. The apparatus as in claim 1, wherein a material of the moisture-inhibiting portion adhered to the lower surface of the MDF portion is different from a material of the moisture-inhibiting portion adhered to the lateral surface of the MDF portion.

10. The apparatus as in claim 1, wherein the apparatus comprises an architectural panel.

11. The apparatus as in claim 1, further comprising a paint layer above the upper surface of the glass portion.

12. The apparatus as in claim 1, further comprising a paint layer above the upper surface of the stress buffer.

13. The apparatus as in claim 1, further comprising a paint layer adhered to at least one of an upper surface of the glass portion or an upper surface of the stress buffer.

14. A method comprising:
adhering a lower surface of a stress buffer to an upper surface of a medium-density fiberboard (“MDF”) portion;
adhering a lower surface of a glass portion to an upper surface of the stress buffer; and
arranging a moisture-inhibiting portion to limit a flow of moisture into and out of the MDF portion through at least one of a lower surface of the MDF portion or a lateral surface of the MDF portion.

15. The method of claim 14, further comprising adjusting a moisture content of the MDF portion before arranging the moisture-inhibiting portion.

16. The method as in claim 14, wherein the adjusted moisture content of the MDF portion is controlled according to historical humidity conditions for an expected end-use location.

17. The method as in claim 14, wherein the stress buffer comprises steel.

18. The method as in claim 14, wherein the moisture-inhibiting portion comprises aluminum.

19. The method as in claim 14, wherein the moisture-inhibiting portion further comprises polyethylene terephthalate.

20. The method as in claim 14, wherein the moisture-inhibiting portion is adhered to at least one of the lower surface of the MDF portion or the lateral surface of the MDF portion.

21.-25. (canceled)
